(19) United States
(12) Patent Application Publication
(10) Pub. No.: US 2003/0129349 A1
(43) Pub. Date: Jul. 10, 2003

(54) Label product with a repositionable backing substrate for adhesively and repositionably attaching to a document

(76) Inventors: Tsung-Tien Kuo, Kaohsiung Hsien (TW); Jen-Rong Liu, Feng-Shan City (TW); Ho-Tsai Lin, Kaohsiung City (TW); Ho-Chi Chen, Kaohsiung City (TW)

Correspondence Address: NIXON & VANDERHYE, P.C., 8th Floor, 1100 North Glebe Road, Arlington, VA, 22201-4714, US

(21) Appl. No.: 10/036,477

(22) Filed: Jan. 7, 2002

(51) Int. Cl. B32B 9/00

(52) U.S. Cl. 428/42.3

(57) ABSTRACT

A label product includes a first backing substrate, a plurality of second backing substrates adhesively and repositionably attached to the first backing substrate, and a plurality of labels adhesively and repositionably attached to each second backing substrate. Each second backing substrate has opposite first and second side faces. The first side face of each second backing substrate is coated with a pressure sensitive adhesive layer attached to the first backing substrate. Each label has a side face that is coated with a pressure sensitive adhesive layer attached to the second side face of a respective second backing substrate.

### BACKGROUND OF THE INVENTION

1. Field of the Invention

This invention relates to a label product with a repositionable backing substrate for adhesively and repositionably attaching to a document.

2. Description of the Related Art

FIG. 1 illustrates a conventional label product 2 that can be applied to a document 3 for the purpose of identification, indexing, etc., and that includes a backing substrate 21 coated with a release agent layer on an upper face 211 thereof, and a plurality of labels 22, each of which is coated with an adhesive layer on a bottom face 222 thereof so as to be adhesively and releasably attached to the release agent layer on the upper face 211 of the backing substrate 21 and so as to be adapted to be adhesively attached to the document 3. However, the label product 2 tends to be easily misplaced so that reading of the document 3 tends to be interrupted when a label is needed, which results in a waste of time in searching for the label product 2 and in resuming the reading of the document 3 where the interruption occurred.

### SUMMARY OF THE INVENTION

Therefore, it is an object of the present invention to provide a label product that is capable of overcoming the aforesaid drawbacks.

According to the present invention, there is provided a label product adapted to be adhesively and repositionably attached to a document having a plurality of stacked sheets. The label product comprises: a sheet-type first backing substrate having a side face; a plurality of sheet-type second backing substrates each having opposite first and second side faces, the first side face being coated with a first pressure sensitive adhesive layer so as to be adhesively and repositionably attached to the side face of the first backing substrate and so as to be adapted to be adhesively and repositionably attached to the document; and a plurality of sheet-type printable labels attached to the second side face of each of the second backing substrate. Each of the printable labels has a side face that is coated with a second pressure sensitive adhesive layer so as to be adhesively and repositionably attached to the second side face of a respective one of the second backing substrates and so as to be adapted to be adhesively and repositionably attached to a selected one of the sheets of the document.

### BRIEF DESCRIPTION OF THE DRAWINGS

In drawings which illustrate a preferred embodiment of the invention,

FIG. 1 illustrates a conventional label product with a plurality of labels adapted for use on a document;

FIG. 2 is a perspective view of a preferred embodiment of a label product of this invention, in the form of a roll;

FIG. 3 is a sectional view to illustrate a section of the label product of FIG. 2; and

FIG. 4 is a schematic view to illustrate how the label product of FIG. 2 is used on a document.

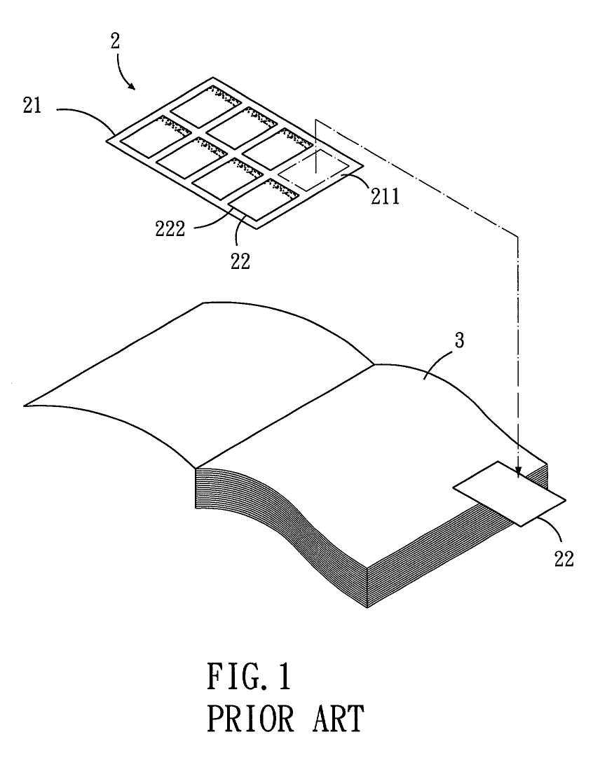

### DETAILED DESCRIPTION OF THE PREFERRED EMBODIMENT

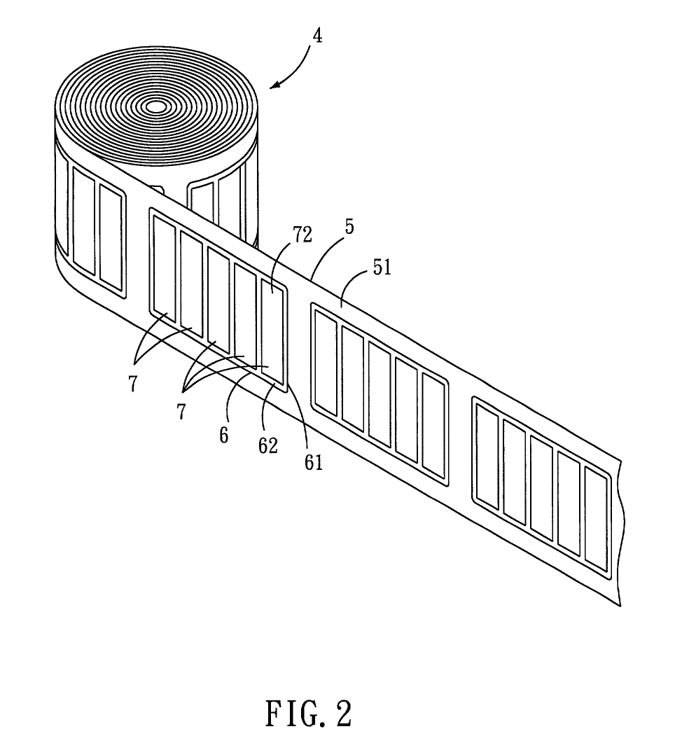

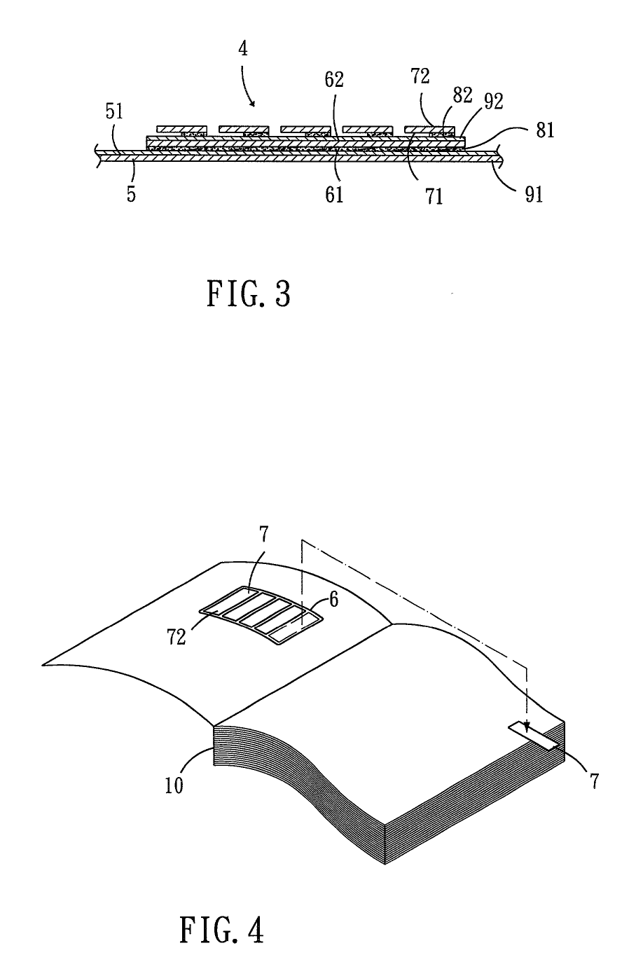

FIGS. 2 and 3 illustrate a roll of a label product 4 embodying this invention and adapted to be adhesively and repositionably attached to a document 10 having a plurality of stacked sheets (see FIG. 4)

The label product 4 includes: a sheet-type first backing substrate 5 having a side face 51; a plurality of sheet-type second backing substrates 6 each having opposite first and second side faces 61, 62, the first side face 61 being coated with a first pressure sensitive adhesive layer 81 so as to be adhesively and repositionably attached to the side face 51 of the first backing substrate 5 and so as to be adapted to be adhesively and repositionably attached to the document 10; and a plurality of sheet-type printable labels 7 attached to the second side face 62 of each of the second backing substrates 6. Each of the printable labels 7 has a side face 71 that is coated with a second pressure sensitive adhesive layer 82 so as to be adhesively and repositionably attached to the second side face 62 of a respective one of the second backing substrates 6 and so as to be adapted to be adhesively and repositionably attached to a selected one of the sheets of the document 10.

The first side face 61 of each of the second backing substrates 6 and the side face 71 of each of the labels 7 can be fully or partially coated with the first and second pressure sensitive adhesive layers 81, 82, respectively.

Preferably, the side face 51 of the first backing substrate 5 is coated with a first release agent layer 91 so as to reduce adhesive bonding force between the first pressure sensitive adhesive layer 81 and the side face 51 of the first backing substrate 5.

Preferably, the second side face 62 of each of the second backing substrates 6 is coated with a second release agent layer 92 so as to reduce adhesive bonding force between the second pressure sensitive adhesive layer 82 and the second side face 62 of a respective one of the second backing substrates 6.

Preferably, the first backing substrate 5 is made from a paper sheet coated with the first release agent layer 91.

Preferably, each of the second backing substrates 6 is made from a paper sheet coated with the second release agent layer 92 and the first pressure sensitive layer 81.

Preferably, each of the labels 7 is made from a paper sheet coated with the second pressure sensitive adhesive layer 82. More preferably, each of the labels 7 is made from a transparent material selected from a group consisting of polypropylene film, polyethylene film, polyvinyl chloride film, polyester film, and cellulose acetate film, and is coated with a writable pigment layer (not shown) at an opposite side of the second pressure sensitive adhesive layer 82.

Referring to FIG. 4, since one or more of the second backing substrates 6 with the labels 7 thereon can be adhesively and repositionably attached to the selected one of the sheets of the document 10 being read, the aforementioned drawbacks associated with the prior art can be eliminated.

With the invention thus explained, it is apparent that various modifications and variations can be made without departing from the spirit of the present invention. It is therefore intended that the invention be limited only as recited in the appended claims.

We claim:

1. A label product adapted to be adhesively and repositionably attached to a document having a plurality of stacked sheets, said label product comprising:
a sheet-type first backing substrate having a side face;
a plurality of sheet-type second backing substrates each having opposite first and second side faces, said first side face being coated with a first pressure sensitive adhesive layer so as to be adhesively and repositionably attached to said side face of said first backing substrate and so as to be adapted to be adhesively and repositionably attached to the document; and
a plurality of sheet-type printable labels attached to said second side face of each of said second backing substrates, each of said printable labels having a side face that is coated with a second pressure sensitive adhesive layer so as to be adhesively and repositionably attached to said second side face of a respective one of said second backing substrates and so as to be adapted to be adhesively and repositionably attached to a selected one of the sheets of the document.

2. The label product of claim 1, wherein said side face of said first backing substrate is coated with a first release agent layer so as to reduce adhesive bonding force between said first pressure sensitive adhesive layer and said side face of said first backing substrate.

3. The label product of claim 2, wherein said second side face of each of said second backing substrates is coated with a second release agent layer so as to reduce adhesive bonding force between said second pressure sensitive adhesive layer and said second side face of a respective one of said second backing substrates.

4. The label product of claim 3, wherein said first backing substrate is made from a paper sheet coated with said first release agent layer.

5. The label product of claim 4, wherein each of said second backing substrates is made from a paper sheet coated with said second release agent layer and said first pressure sensitive layer.

6. The label product of claim 5, wherein each of said labels is made from a paper sheet coated with said second pressure sensitive adhesive layer.

7. The label product of claim 6, wherein each of said labels is made from a transparent material selected from a group consisting of polypropylene film, polyethylene film, polyvinyl chloride film, polyester film, and cellulose acetate film, and is coated with a writable pigment layer at an opposite side of said second pressure sensitive adhesive layer.

8. The label product of claim 1, wherein said second side face of each of said second backing substrates is coated with a second release agent layer so as to reduce adhesive bonding force between said second pressure sensitive adhesive layer and said second side face of a respective one of said second backing substrates.

9. The label product of claim 1, wherein said first side face of each of said second backing substrates is fully coated with said first pressure sensitive adhesive layer.

10. The label product of claim 1, wherein said first side face of each of said second backing substrates is partially coated with said first pressure sensitive adhesive layer.

11. The label product of claim 1, wherein said side face of each of said labels is fully coated with said second pressure sensitive adhesive layer.

12. The label product of claim 1, wherein said side face of each of said labels is partially coated with said second pressure sensitive adhesive layer.
